(19) United States
(12) Patent Application Publication
(10) Pub. No.: US 2025/0078397 A1
(43) Pub. Date: Mar. 6, 2025

(54) PRIOR FOR HIGH-RESOLUTION IMAGE SYNTHESIS

(71) Applicant: Google LLC, Mountain View, CA (US)

(72) Inventors: Abhimitra Meka, Redwood City, CA (US); Marcel Bühler, Truttikon (CH); Kripasindhu Sarkar, Zurich (CH); Tanmay Shah, San Ramon, CA (US); Gengyan Li, Volketswil (CH); Daoye Wang, Zurich (CH); Leonhard Helminger, Zurich (CH); Sergio Orts Escolano, San Francisco, CA (US); Dmitry Lagun, San Jose, CA (US); Thabo Beeler, Egg (CH)

(21) Appl. No.: 18/823,613

(22) Filed: Sep. 3, 2024

Related U.S. Application Data
(60) Provisional application No. 63/580,159, filed on Sep. 1, 2023.

(51) Int. Cl. G06T 15/20; G06T 5/60

(52) U.S. Cl. CPC G06T 15/205; G06T 5/60; G06T 2207/10024; G06T 2207/20081; G06T 2207/20084; G06T 2207/30201

(57) ABSTRACT

A method including determining a viewpoint, generating a first image using an image generator, the first image including an object in a first orientation based on the viewpoint, modifying the image generator based on a second orientation of the object, and generating a second image based on the first image using the modified image generator.

### CROSS-REFERENCE TO RELATED APPLICATION

This application claims priority to U.S. Provisional Patent Application No. 63/580,159, filed on Sep. 1, 2023, entitled “A DATA-DRIVEN VOLUMETRIC PRIOR FOR FEW-SHOT ULTRA HIGH-RESOLUTION FACE SYNTHESIS”, the disclosure of which is incorporated by reference herein in its entirety.

### BACKGROUND

Reconstruction and novel view synthesis of faces can be challenging problems in three-dimensional (3D) computer vision. Achieving high-quality photorealistic synthesis can be difficult due to the underlying complex geometry and light transport effects exhibited by organic surfaces. Traditional techniques use explicit geometry and appearance representations for modeling individual face parts such as hair, skin, eyes, teeth, and lips. Such methods often require specialized expertise and hardware and limit the applications to professional use cases.

### SUMMARY

Example implementations can relate to a prior model (or volumetric prior) trained using a multi-view dataset of diverse image content. Some example models can include a neural radiance field (NeRF) conditioned on learnt per-identity embeddings trained to generate 3D views with a default pose from the dataset. In some implementations the prior model can be a volumetric prior configured for human faces. In some implementations, the dataset of diverse image content can be images of diverse human faces.

In a general aspect, a device, a system, a non-transitory computer-readable medium (having stored thereon computer executable program code which can be executed on a computer system), and/or a method can perform a process with a method including determining a viewpoint, generating a first image using an image generator, the first image including an object in a first orientation based on the viewpoint, modifying the image generator based on a second orientation of the object, and generating a second image based on the first image using the modified image generator.

In another general aspect, a device, a system, a non-transitory computer-readable medium (having stored thereon computer executable program code which can be executed on a computer system), and/or a method can perform a process with a method including estimating a parameter of a camera, aligning an object to a first pose based on the parameter of the camera, configuring a model based on a second pose, and generating an image, including the object, in the second pose using the model.

In another general aspect, a device, a system, a non-transitory computer-readable medium (having stored thereon computer executable program code which can be executed on a computer system), and/or a method can perform a process with a method including estimating a camera parameter, aligning an object to a predefined pose based on the camera parameter, defining a numerical representation based on a target object pose, adapting a model based on the numerical representation, and generating an image including the object in the target object pose using the model.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1A illustrates a pictorial diagram of a data flow for image synthesis according to an example implementation.

FIG. 1B illustrates a block diagram of an image synthesis data flow according to an example implementation.

FIG. 1C illustrates a block diagram of an image synthesis data flow according to an example implementation.

FIG. 2A illustrates a block diagram of a data flow for training a model according to an example implementation.

FIG. 2B illustrates a block diagram of a data flow for image reconstruction according to an example implementation.

FIG. 2C illustrates a block diagram of a data flow for high-resolution image reconstruction according to an example implementation.

FIG. 3 illustrates a block diagram of a prior model architecture according to an example implementation.

FIG. 4 illustrates a block diagram of a method for generating an image according to an example implementation.

FIG. 5 illustrates another block diagram of a method for generating an image according to an example implementation.

FIG. 6 illustrates another block diagram of a method for generating an image according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Content developers often use images of people or other objects in their content. For example, a webpage developer could use pictures of people or other objects on a webpage. At times the image is a computer-generated image including a computer-generated object, objects, person and/or people in the computer-generated image. In other words, the person or object may not be a real person or object, or the person or object may not have had a real image captured using a camera. However, the image may be a photorealistic image of the person or object. In other words, the image can appear to be an image of a real object taken by a camera.

Such computer-generated images, as described above, can be generated using a model (e.g., a machine learned model, a trained model, a trained neural network, and the like). However, these models can require 100,000 or more images in order to be trained to generate an image. Acquiring 100,000 or more unique high-quality (e.g., high resolution) images can be difficult. Therefore, at least one technical problem for training a model to generate an image (e.g., a photorealistic image) can include acquiring the number of images needed to train the model. At least one technical solution to the technical problem can include using a computer to generate a large quantity of images that can be used to train a model. At least one technical effect of the technical solution can be that a sufficient number of high-quality (e.g., high resolution) images can be acquired for training a model to generate images in an application.

In some implementations, the technical solution can include using a second model to generate images used to train the above-mentioned model. The second model can be trained using image data. In some implementations, the image data can be relatively low quality (e.g., low resolution). In some implementations, the image data can include a relatively small number of images for training the second model. After training the second model, the second model can be used to generate the above-mentioned high-quality (e.g., high resolution) images. In some implementations, the second model can use a reduced (e.g., a minimal number (e.g., one or two)) images as a basis for generating the above-mentioned high-quality images.

For example, in some implementations, computer generation of images can include modifying an existing image. The existing image can be an image captured by a camera and/or computer generated (e.g., photorealistic image). Modifying the existing image can include using a computing device to change the pose of an object, remove a background, replace a background, replacing an object with another object, convert a two-dimensional (2D) image to a three-dimensional (3D) image and/or the like. Modifying and/or changing the appearance of some objects (e.g., human faces) has proven to be especially challenging in some implementations.

In some implementations, modifying the object can include modifying a human face. Reconstruction and novel view synthesis of faces can be challenging problems in three-dimensional (3D) computer vision. Achieving high-quality photorealistic synthesis can be difficult due to the underlying complex geometry and/or light transport effects exhibited by organic surfaces. Advances in neural rendering have enabled highly realistic synthesis of human faces including complex appearance and reflectance effects of hair and skin. These technologies typically use a large number of multi-view input images, making the process computer hardware resource intensive and cumbersome, limiting applicability to unconstrained settings.

At least one technical problem with traditional techniques in photorealistic image synthesis is that these techniques use explicit geometry and appearance representations for modeling individual parts associated with a face such as hair, skin, eyes, teeth, and lips. These techniques often use specialized expertise and/or hardware and limit the applications to professional use cases.

Recent advances in volumetric modeling have enabled learned, photorealistic view synthesis of both general scenes and specific object categories such as faces from two-dimensional (2D) images alone. Such approaches can be suited to model challenging effects such as hair strands and skin reflectance. The higher dimensionality of the volumetric reconstruction problem can be more ambiguous than surface-based methods. Thus, at least one technical problem with the initial developments in neural volumetric rendering techniques is that the techniques rely on an order-of-magnitude higher number of input images (e.g., >100×, 1000×, 10,000×, or more) to make the solution tractable. Such a large image acquisition can limit (e.g., due to cost) applications to wider casual consumer use cases. Hence, few-shot volumetric reconstruction, of both general scenes and specific object categories such as human faces, remains a technical problem.

At least one technical problem associated with the ambiguity of volumetric neural reconstruction from few images has generally been approached in 3 ways: 1) regularization: using natural statistics to constrain the density field better such as low entropy along camera rays, 3D spatial smoothness and deep surfaces to avoid degenerate solutions such as floating artifacts; 2) initialization: meta-learnt initialization of the underlying representation (network weights) to aid faster and more accurate convergence during optimization; and 3) data-driven subspace priors: using large and diverse datasets to learn generative or reconstructive priors of the scene volume. For human faces, large datasets have proved to be particularly attractive in learning a smooth, diverse, and differentiable subspace that allow for few-shot reconstruction of novel subjects by performing inversion and fine-tuning of the model on a small set of images of the target identity.

However, general datasets and generative models also suffer from disadvantages: 1) The sharp distribution of frontal head poses in these datasets prevents generalization to more extreme camera views; and 2) the computational challenge of training a 3D volume on large datasets results in very limited output resolutions.

At least one technical solution to the above-mentioned technical problems includes a volumetric prior that is learned from a multi-view dataset of diverse image content. Some example models include a neural radiance field (NeRF) conditioned on learnt per-identity embeddings trained to generate 3D consistent views from the dataset. In some implementations the volumetric prior can be a volumetric prior configured for human faces. In some implementations, the dataset of diverse image content can be images of diverse human faces. At least one technical effect of the technical solution is that a sufficient number of images can be generated to enable the training of volumetric models for photorealistic view synthesis of both general scenes and specific object categories such as faces. For example, a high-quality volumetric representation (e.g., a three-dimensional image) of a novel subject can be obtained by model fitting to 2 or 3 camera views of arbitrary resolution. In some implementations, as few as two views of casually captured images can be used as input at inference time.

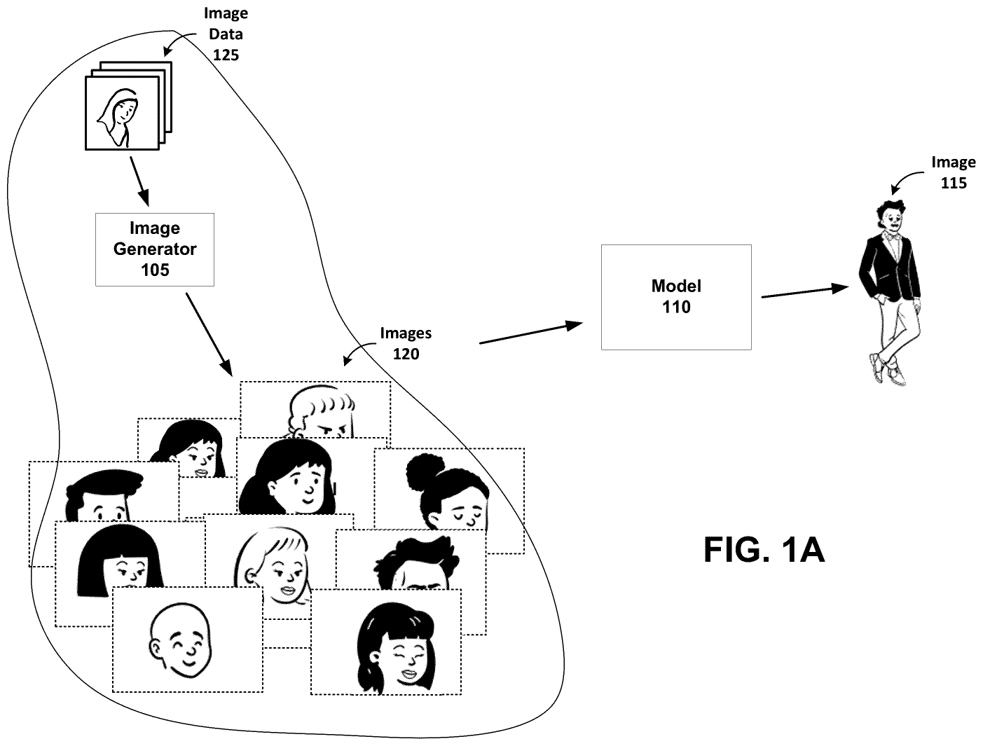

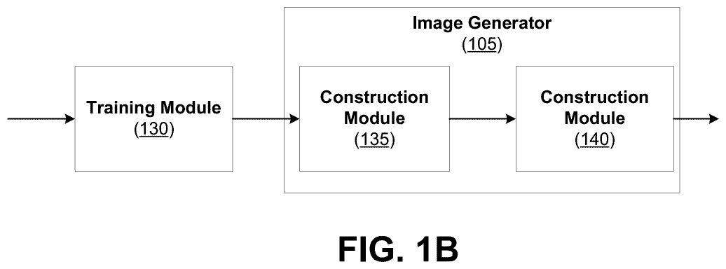

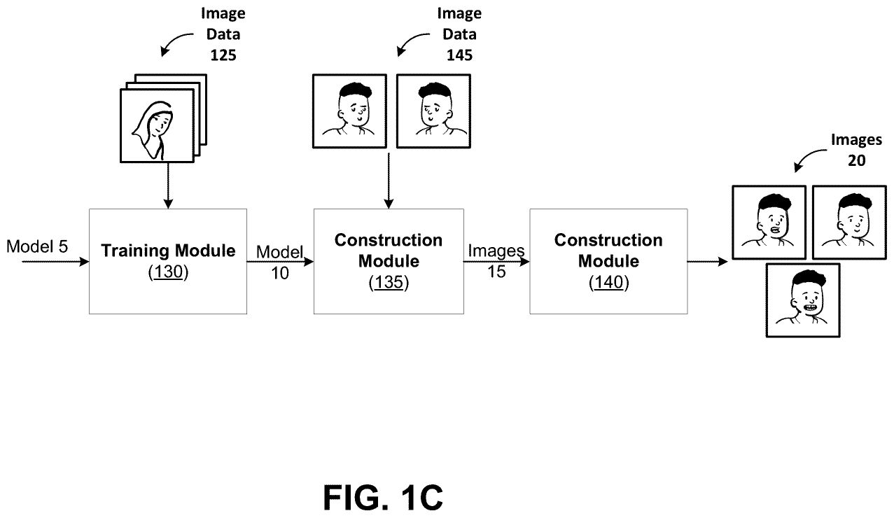

Referring to FIG. 1A, a model 110 can be used to generate an image 115. Images 120 can be used to train model 110. However, adequately training model 110 to generate image 115 as an image that appears to have been captured by a camera (e.g., a photorealistic image) can require images 120 to include, for example, 100,000 or more images. In some implementations an image generator 105 can be used to generate images 120. In such a case, images 120 can be computer-generated images. In some implementations, images 120 can be high-quality (e.g., high resolution) computer-generated images. In some implementations, image generator 105 can also use a model to generate images 120. This model can be trained using image data 125. In some implementations, image data 125 can be relatively low quality (e.g., low resolution). In some implementations, image data 125 can include a relatively small number of images for training a model.

FIGS. 1B and 1C illustrate a block diagram of an image synthesis data flow according to an example implementation. As shown in FIG. 1B, the data flow can include a training module 130, a construction module 135, and a construction module 140. The training module 130 can be configured to train and/or help train a model. For example, the training module 130 can be configured to train and/or help train a prior model. For example, the training module 130 can be configured to train and/or help train a prior model. For example, the training module 130 can be configured to train and/or help train a prior model. For example, the training module 130 can be configured to train and/or help train a volumetric prior model. For example, the training module 130 can be configured to train and/or help train a data-driven volumetric prior model.

Construction module 135 and construction module 140 can be configured to generate an image(s). For example, construction module 135 and construction module 140 can be configured to reconstruct an image(s). For example, construction module 135 and construction module 140 can be configured to synthesize an image(s). For example, construction module 135 and construction module 140 can be configured to generate an image(s) using the model trained by the training module 130. In an example implementation, the construction module 135 can be configured to generate a first image at a first resolution and the construction module 140 can be configured to generate a second image at a second resolution. The second resolution can be greater than the first resolution. The second image can be a higher resolution version of the first image.

In an example implementation, As shown in FIG. 1C, a model 5 (e.g., a prior model) is provided (e.g., input) to the training module 130. Training module 130 can train model 5 using image data 125. Accordingly, the training module 130 can generate model 10 based on model 5 and the image data 125. Model 10 can be a trained model (e.g., a trained prior model). After training, model 10 can be configured to generate an image based on image data 125. In some implementations, model 10 can be configured to generate image(s) with an object (e.g., human face) having a predefined pose (e.g., a face looking in a predetermined (e.g., straight ahead) direction).

In some implementations, the predefined pose can be based on a viewpoint (e.g., of the camera or virtual camera). A viewpoint can be an angle and distance from which a camera or virtual camera views an object. For example, a viewpoint can be a perspective view of an object through the lens of a camera or virtual camera. For example, the viewpoint can be based on a position (e.g., eye level, ground level, above, and/or the like) of a camera or virtual camera in relation to the object. For example, the viewpoint can be based on an angle of the camera or virtual camera in relation to the object. For example, the viewpoint can be based on depth and spatial relationships of the object(s) and/or scene. In some implementations, the viewpoint can be determined using camera parameters. For example, the viewpoint can be determined (defined, quantified, enumerated, and/or the like) using camera parameters. (e.g., pose, focal length, pixel size, and the like).

In some implementations, the predefined pose can be based on a camera parameter. For example, the camera parameter can be associated with a human face looking straight into the camera. Accordingly, in some implementations, model 10 can be configured (e.g., trained) to align an object to a predefined pose based on the camera parameter. A camera parameter can include camera extrinsic information and camera intrinsic information. Camera extrinsic information can define the position and orientation or pose of the camera in 3D space. Camera intrinsic information can define internal properties. For example, camera intrinsic information can include focal length, pixel size, and image origin of the camera.

Model 10 can be a trained version of model 5. Model 5 and/or model 10 can be a prior model. In statistics, a prior can represent a viewpoint or confidence in something before observing some data. Therefore, a prior model can be a model that includes assumptions about the parameters of the model before observing any data. In some implementations, a prior model can have an architecture and initial weights prior to training the model. In some implementations, the prior model can predict an image reconstruction with a minimal amount of confidence in the prediction. In some implementations, a model can be trained to be a prior model should some follow-on operation be configured to optimize the prior model.

Next, construction module 135 generates images 15 using model 10. Construction module 135 can generate images 15 based on image data 145. Construction module 135 can generate images 15 as novel views of an object included in image data 145. Construction module 135 can generate images 15 in novel views based on a target object pose. The target object pose can correspond to target weights input to model 10. The target weights can be used to modify weights associated with model 10. In some implementations, a numerical representation can be defined based on the target object pose. In some implementations, the numerical representation can be an embedding associated with model 10. In some implementations, a numerical representation can be referred to as a representation. In some implementations, images 15 can have a low-resolution (e.g., 512×768). The low-resolution can be predefined by the architecture of model 5 and model 10. In some implementations, the low-resolution can be associated with image data 125 and/or image data 145.

Next, construction module 140 generates images 20 using an adapted (e.g., modified, optimized, and/or the like) model 10. In some implementations, model 10 can be adapted based on the numerical representation. In some implementations, model 10 can be adapted based on a modified (e.g., optimized) numerical representation. In some implementations, the construction module 140 can be configured to generate images 20 including an object in the target object pose using the model 10 (e.g., the adapted model 10). In some implementations, images 20 can have a high-resolution as compared to images 15. In some implementations, the adapting of model 10 can define the high-resolution of images 20. In some implementations, images 20 can include novel views of the object (e.g., face) included in image data 145.

In some implementations a pre-processing step configured to align the geometry of the captured subjects can be performed. This geometric alignment of the training identities can allow an example prior model to learn a continuous latent space using only image reconstruction losses.

Example implementations include a volumetric prior model (e.g., human face prior) that enables the synthesis of high-resolution, ultra-high resolution novel views of subjects that are not part of the prior's training distribution. This prior model includes an identity-conditioned NeRF, trained on a dataset of low resolution multi-view images (e.g., image data 125) of diverse humans with known camera calibration. Camera calibration can be the process of estimating the parameters of a camera model approximating the camera that produced a given photograph or video. Camera calibration can determine which incoming light ray is associated with each pixel on the resulting image. For example, the camera parameters can be represented in a 3×4 projection matrix called the camera matrix. The extrinsic parameters define the camera pose (position and orientation) while the intrinsic parameters specify the camera image format (focal length, pixel size, and image origin).

A simple sparse landmark-based 3D alignment of the training dataset allows an example model to learn a smooth latent space of geometry and appearance despite a limited number of training identities. A high-quality volumetric representation of a novel subject can be generated by model-fitting to two (2) or three (3) camera views of arbitrary resolution. Some implementations can use as few as two views of casually captured images as input at inference time.

In some implementations a model inversion can be performed to compute the embedding for a novel target identity from the given small set of views of arbitrary resolution. In an out-of-model fine-tuning step, the resulting embedding and model can be further trained with the given images. This results in a NeRF model of the target subject that can synthesize high-quality images.

Image synthesis can be the process of artificially generating images that contain some particular desired content. For example, image synthesis can include modifying an image such that an object in the image has a different pose in the modified image. For example, image synthesis can include combining (e.g., mapping) portion(s) of two or more images into a combined image. Image synthesis can be performed using, for example, an image-to-image translation network and/or a generative adversarial network (GAN). In some implementations, image synthesis can include removing (e.g., filtering, masking, and the like) a portion of an image and replacing the removed portion of an image with a modified portion (e.g., same portion) of the image.

Some example implementations include a prior model for faces that can be fine-tuned to very sparse views. The fine-tuned model can be configured to generate ultra-high resolution novel view synthesis with intricate details like individual hair strands, eyelashes, and skin pores. Example implementations can include a prior model for faces that can be fine-tuned to generate a high-quality volumetric 3D representation of a target identity from two or more views. Example implementations include ultra-high resolution 3D consistent view-synthesis (e.g., 4k and greater resolution). Example implementations include generalization to in-the-wild indoor and outdoor captures, including challenging lighting conditions. In some implementations the prior model can include a novel data-driven subspace prior.

Some implementations use a neural radiance field (NeRF) model. A NeRF can be configured to represent a scene as a volumetric function f: (x, d)→(c, σ) which maps 3D locations x to a radiance c and a density σ. In some implementations, the volumetric function can be modeled using a multi-layer perceptron (MLP). The radiance can be further conditioned on a view direction d to support view dependent effects such as secularity.

In order to more effectively represent and learn high frequency effects, each location can be positionally encoded before being passed to the MLP. Given a NeRF, a pixel can be rendered by integrating along its corresponding camera ray in order to obtain the radiance or color value ĉ=F(r). Assuming a predetermined near and far camera plane tₙ and t_{f}, the integrated radiance of the camera ray can be computed using the following equation:

$$F ( r ) = {\int }_{{t}_{n}}^{{t}_{f}} T ( t ) σ ( r ( t ) ) c ( r ( t ) , d ) dt , \qquad ( 1 )$$

$$where$$

$$T ( t ) = exp ( - {\int }_{{t}_{n}}^{t} σ ( r ( s ) ) ds ) . \qquad ( 2 )$$

Eqn. 1 and 2, can be estimated using raymarching. For example, a NeRF implementation can approximate the ray into a discrete number of sample points and estimate the alpha value of each sample by multiplying its density with the distance to the next sample. A quality can be improved using coarse-to-fine rendering, by first distributing samples uniformly between the near and far planes, and then importance sampling the quadrature weights. NeRF can resolve anti-aliasing resulting from discrete sampling in a continuous space. This is achieved by sampling conical volumes along the ray. NeRF can also include an efficient pre-rendering step including a uniformly sampled coarse rendering pass by a proposal network, which predicts the sampling weights instead of the density and color values using a lightweight MLP. This is followed by an importance-sampled NeRF rendering step.

In some implementations, a NeRF-based framework used for high-resolution, multi-view consistent appearance and transparency modelling from a sparse number of views. NeRF can include casting a cone from each pixel to minimize aliasing artifacts and leverages a proposal MLP to reason about the rough surface. To handle sparse-view training, a patch-wise smooth (and sometimes regularized) with an annealing strategy can be used to regulate the training process and preserve high fidelity. Additionally, in order to enhance the spatial signal and modeling fine details,

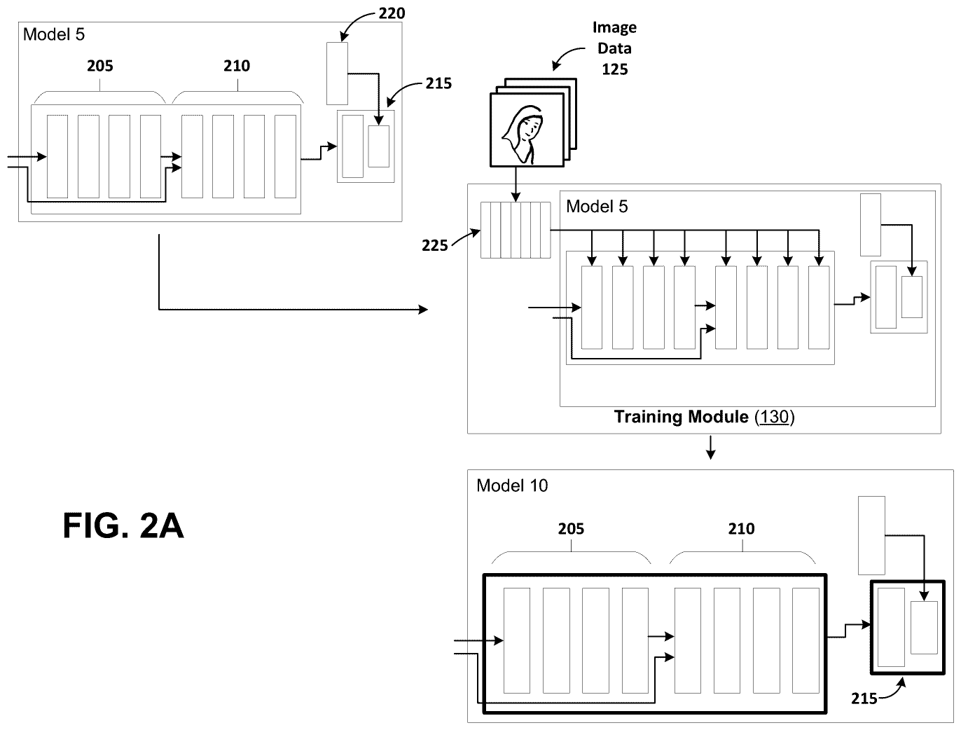

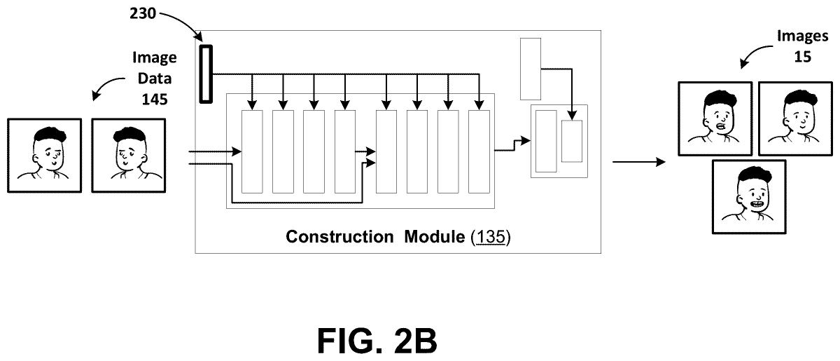

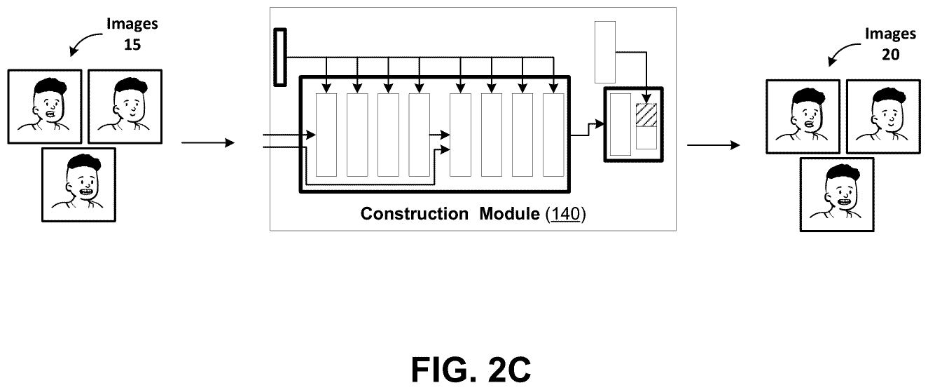

FIG. 2A illustrates a block diagram of a data flow for training a model according to an example implementation. An example prior model (e.g., model 5) can be a conditional neural radiance field F₀ that can be trained as an auto-decoder. Given a ray r and a latent code w, F₀ predicts a color ĉ=F_{θ}(r, w) with volumetric rendering. The architecture of the prior model can include two MLPs. In some implementations the MLPs can be conditioned on a latent code w_{identity} as input, representing the identity.

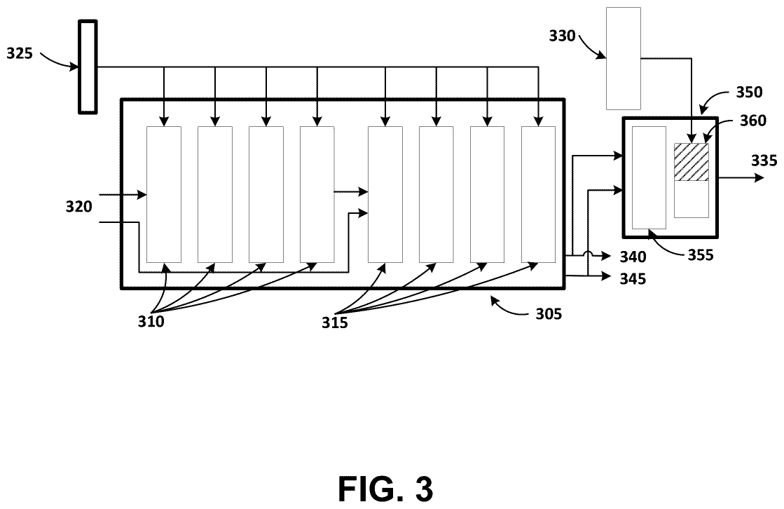

MLP 205 (e.g., the first MLP) can be configured to predict density (σ) only. MLP 210 (e.g., the second MLP or the NeRF MLP) can be configured to predict both density (σ) and color (c). Both MLPs take an encoded point \hat{γ}ₓ(x) and a latent code w as input, where \hat{γ}ₓ(⋅) denotes a function for integrated positional encodings. MLP 210 can further take the positionally encoded view direction \hat{γ}_{ν}(d) as input (e.g., without integration for the positional encoding). FIG. 3 illustrates further details of an example prior model. The latent code can be concatenated at each layer. Unlike generative models, an example model can also condition (e.g., trained) on the view direction d. As shown in FIG. 2A, model 5 further includes an integration module 215. The integration module 215 can be configured to fuse the features that are output from MLP 205 and/or MLP 210 and integrate the result to generate a color(s) (e.g., color ĉ). The integration module 215 can be configured to regularize the integrated result. Regularizing the integrated result can reduce overfitting of the model output. Regularizing can marginally decrease training accuracy to increase in generalization (or widen applicability) of the model. Overfitting can include producing accurate predictions for training data but not for new data. The integration module 215 can be configured to generate images with an object (e.g., head) in a predefined object pose based on pose block 220. In other words, pose block 220 can be and/or include data configured to align (e.g., head alignment) an object (e.g., head) in a predefined object pose. In other words, a target object pose can be a default or predefined object pose during training of the prior model.

For training (e.g., training module 130), some implementations can be configured to sample random rays r and render the output color ĉ. Given N trainings subjects (e.g., image data 125), some implementations can optimize over both the network parameters θ and the latent codes w_{1..N} 225. An example objective function can be:

$${θ , {w}_{1 .. N}}_{arg min}^{} {ℒ}_{prior} = {ℒ}_{recon} + {λ}_{prop} {ℒ}_{prop} \qquad ( 3 )$$

with λₚᵣₒₚ=1. The loss terms L_{recon} and Lₚᵣₒₚ can be described for a single ray. The final loss can be computed as the expectation over some, most, substantially all, and/or all rays in the training batch.

The objective function has a data term comparing the predicted color with the ground truth [symbol] _{recon}=∥F_{θ}(r, w)−c∥₁, as well as a weight distribution matching loss term between MLP 210 and MLP 205 [symbol] ₚᵣₒₚ. Some implementations may not regularize the latent space and disable the distortion loss. Some implementations may use a plurality of steps or iterations for a model training operation to be effective. For example, a prior model can be trained using one (1) million iterations with multi-view images of resolution 512×768 as input or training data. As shown by model 10, the MLP 205, MLP 210, and the integration module 215 are optimized (shown with the bold lines). In other words, the MLP 205, MLP 210, and the integration circuit of model 5 can be trained (e.g., optimized to generate model 10.

In some implementations, referring to FIGS. 1B and 1C, training module 130 can be a preprocessing and head alignment operation, construction module 135 can be an inversion operation, and construction module 140 model fitting operation.

Preprocessing and head alignment operation: In some implementations the camera parameters can be estimated, and the objects (e.g., heads) can be aligned to a predefined pose during the data preprocessing stage. In some implementations the cameras can be calibrated, and 3D key-points can be estimated by triangulating detected 2D key-points. In some implementations a key-point estimation method can be used to estimate the camera positions and 3D key-points. In some implementations a similarity transform can be aligned and computed to a predefined set of 3D key-points (e.g., outer eye corners, nose, mouth center, and the chin) in a canonical pose.

FIG. 2B illustrates a block diagram of a data flow for image reconstruction (e.g., inversion operation) according to an example implementation. In some example implementations, the reconstruction results can depend on a good initialization of the object (e.g., face) geometry. For example, an optimization problem can be solved to find a latent code that produces a good starting point. Given K views of a target identity, some implementations can optimize with respect to a new latent code while keeping the network weights frozen. Let P be a random patch sampled from one of the K images of the target identity and \hat{P}_{w} be a patch rendered by the prior model when conditioning on the latent code w. The latent code of the target object pose 230 or target identity w_{target} can be recovered by minimizing the following objective function:

$${w}_{target} = {w}_{arg min}^{} {ℒ}_{recon} + {λ}_{LPIPS} {ℒ}_{LPIPS} \qquad ( 4 )$$

$$where$$

$${ℒ}_{recon} = \frac{1}{\vert P \vert} ‖ {\hat{P}}_{w} - P ‖$$

is the same loss as in Eqn. 3, but computed over an image patch, and [symbol] _{LPIPS}(\hat{P}_{w}, P) is a perceptual loss with λ_{LPIPS}=0.2. In some implementations, optimization can be performed at the same resolution as the prior model after removing the background.

FIG. 2C illustrates a block diagram of a data flow for high-resolution image reconstruction (e.g., model fitting) according to an example implementation. In some implementations, the goal of model fitting can be to adapt the weights of the prior model for generating novel views of a target identity at high resolutions. In some implementations model fitting can be performed by fine-tuning the weights of the prior model to a target object pose or target identity from sparse views. In some implementations the prior model can be trained on low resolution and can be optimized to reconstruct a large set of identities from many views for each identity. After model fitting, the model can be configured to generate high-resolution novel views with intricate details like individual hair strands for a single target identity given as few as two views. In some implementations, FIG. 2B illustrates an operation that generates an image having a first resolution and FIG. 2C illustrates an operation that generates an image having a second resolution. Ion some implementations, the first resolution is lower (e.g., significantly lower) than the second resolution.

In some implementations, training a NeRF model on sparse views can lead to artifact generation because of a distorted geometry and overfitting to high frequencies. In some implementations, correctly initializing the weights of the model avoids floater artifacts and leads to high-quality novel view synthesis. In some implementations, the model weights can be initialized with the pretrained prior model and use the latent code Wtarget obtained through inversion. Regularizing the weights of the view branch can cause fuzzy surface structures, which, in some implementations, can be mitigated using a normal consistency loss. In some implementations, the model can be initialized with the weights of the prior and optimize it given the objective function:

$${{θ}_{target} {w}_{target}}_{arg min}^{} {ℒ}_{fit} = {ℒ}_{recon} + {λ}_{prop} {ℒ}_{prop} + {λ}_{normal} {ℒ}_{normal} + {λ}_{v} {ℒ}_{v} \qquad ( 5 )$$

where the loss terms [symbol] _{recon}, [symbol] ₚᵣₒₚ and the hyperparameter λₚᵣₒₚ are the same as in Eq. 3. The regularize for the normal [symbol] ₙₒᵣₘₐₗ is the same as in RefNeRF. We regularize the weights of the view branch with [symbol] _{ν}=∥θ_{ν}∥², where the parameters θ_{ν} correspond to weights of the connections between the encoded view direction and the output, see regularize block 360 of FIG. 3.

In some implementations, set λₙₒᵣₘₐₗ=0.001 and λ_{ν}=0.0001 and optimize

until convergence. Since an example model can generate faces that are aligned to a canonical pose and location, the rendering volume can be bounded by a rectangular box. In some implementations, the density outside this box can be set to zero for the final rendering.

A result of some example implementations can be high-resolution (e.g., 1024×1024) novel view synthesis from sparse (e.g., two or three) inputs. Further, novel view synthesis can become substantially easier when given more views of the target subject (e.g., seven or eight).

Some example implementations can be further capable of fitting to a single image and still produce detailed results. For example, the example model can learn a strong prior overhead geometry which helps it resolve depth ambiguity to reconstruct a cohesive density field for the head, including challenging regions like hair even with just one input.

The above-described example implementations can create ultra-high resolution NeRFs of unseen subjects from as few as two images, yielding a quality that surpasses other state-of-the-art methods. While the method generalizes well along several dimensions such as identity, resolution, viewpoint, and lighting, it is also impacted by the limitations of the dataset.

FIG. 3 illustrates a block diagram of a prior model architecture according to an example implementation. As shown in FIG. 3, the prior model (or model) architecture includes a Nerf block 305 including MLP 310 (equivalent to MLP 205 described above) and MLP 315 (substantially equivalent to MLP 210 described above). MLP 310 and MLP 315 can take an array of encoded points 320 (e.g., \hat{γ}ₓ(x) and a latent code 325 (e.g., w) as input.

The model further includes an integration module 350. The integration module 350 can be configured to fuse the features that are output from MLP 310 and/or MLP 315 and integrate the result to generate a color(s) (e.g., color ĉ). For example, MLP MLP 310 and/or MLP 315 can be configured to generate (e.g., predict) density 340 (e.g., σ) and spatial gradient features 345 (e.g., \vec{n}). The integration module 350 can include MLP 355. MLP 355 can be a one-layer MLP configured to fuse the density 340 and spatial gradient features 345, facilitating further geometry refinement. The integration module 350 can include a regularize block 360. The regularize block 360 can be configured to regularize the integrated result. The regularize block 360 can include two portions such that one of the portions (shown as the slashed portion) can be optimized. For example, the regularize block 360 can include an L1 norm and a L2 norm. The L2 norm can include weights that can be optimized based on [symbol] _{ν} as described above.

The integration module 350 can be configured to generate an image(s) with an object (e.g., head) in a predefined object pose based on pose block 330. In other words, pose block 330 can be and/or include data configured to align (e.g., head alignment) an object (e.g., head) in a predefined object pose target identity (e.g., w_{identity}). In other words, a target object pose can be a default or predefined object pose during training of the prior model. Further, pose block 330 can be and/or include data configured to align (e.g., head alignment) an object (e.g., head) in a target object pose (e.g., w_{target}) when generating (e.g., synthesizing) an image(s). As shown in FIG. 3, the integration module 350 can be configured to generate an image(s) 335 (e.g., images with color ĉ).

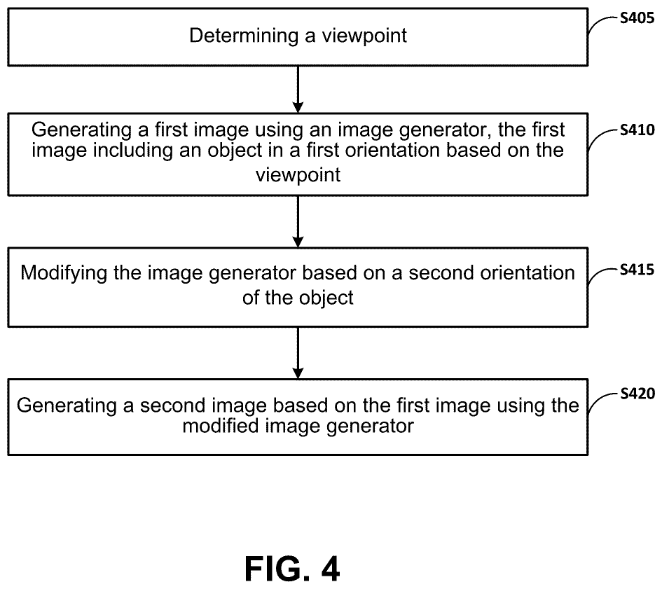

Example 1. FIG. 4 is a block diagram of a method for generating an image according to an example implementation. As shown in FIG. 4, in step S405 determining a viewpoint. In step S410 generating a first image using an image generator, the first image including an object in a first orientation based on the viewpoint. Alternatively, and/or in addition, generating a first image using an image generator, the first image including an object aligned based on the viewpoint. In step S415 modifying the image generator based on a second orientation of the object. Alternatively, and/or in addition, modifying the image generator based on a target alignment for the object. In step S420 generating a second image based on the first image using the modified image generator.

A viewpoint can be an angle and distance from which a camera or virtual camera views an object. For example, a viewpoint can be a perspective view of an object through the lens of a camera or virtual camera. For example, the viewpoint can be based on a position (e.g., eye level, ground level, above, and/or the like) of a camera or virtual camera in relation to the object. For example, the viewpoint can be based on an angle of the camera or virtual camera in relation to the object. For example, the viewpoint can be based on depth and spatial relationships of the object(s) and/or scene. In some implementations, the viewpoint can be determined using camera parameters. For example, the viewpoint can be determined (defined, quantified, enumerated, and/or the like) using camera parameters. (e.g., pose, focal length, pixel size, and the like).

Example 2. The method of Example 1, wherein the image generator can be configured to predict a relationship between a pixel channel and a density in a three-dimensional (3D) plane. For example, the output of an MLP (discussed above) can correspond to a mapping (e.g., relationship) of the color channel, c=(r, g, b) and volume density, o of a pixel in the 2D image plane at the viewpoint. The volume density of the pixel can be determined by taking the integral of volumes along a ray sometimes called volume rendering.

Example 3. The method of Example 2, wherein the density can indicate a 3D spatial smoothness. Spatial smoothness can correspond to a relationship (e.g., difference) between neighboring pixels. For example, spatial smoothing can include averaging data (e.g., pixel values) between neighboring pixels. A lack of spatial smoothness can be related to noise. Therefore, in image generations, a lack of spatial smoothness can be viewed as noise in the generated (or synthesized) image.

Example 4. The method of Example 1, wherein the modifying of the image generator can include modifying a weight of the image generator that corresponds to the second orientation of the object. For example, a 3D representation of a scene can be represented through the weights (of a neural network) of a feed forward MLP (described above). Therefore, modifying (e.g., changing) the weights can change the 3D representation of the scene. In some implementations, the object is the scene. Therefore, modifying (e.g., changing) the weights can change the object. In other words, modifying the weights can change the orientation of the object.

Example 5. The method of Example 1, wherein generating the second image can include predicting a first vector representing density, predicting a second vector representing color, and integrating the first vector and the second vector. In some implementations, the vector can be a mapping, an embedding or the like. In other words, the vector can be the output of a neural network. A vector can represent a portion of an image after the image has been processed by the neural network. The vector can represent features (e.g., objects) of the image.

Example 6. The method of Example 5, wherein generating the second image can further include regularizing a result of integrating the first vector and the second vector. Regularizing can reduce overfitting of the image generator (e.g., neural network, model, and the like) output.

Example 7. The method of Example 1, wherein the image generator can include a first neural network configured to predict a relationship between a pixel channel and a density in a three-dimensional (3D) plane and a second neural network configured to predict a relationship between the pixel channel and the density in the 3D plane and a relationship between the pixel channel and color in the 3D plane.

Example 8. The method of Example 1, wherein the image generator can include a neural network, and modifying of the image generator can include changing a weight associated with the neural network that corresponds to a viewing direction of the object.

Example 9. The method of Example 1, wherein the image generator can include a neural network trained to generate a 3D image using a two-dimensional image.

Example 10. The method of Example 1 can further include receiving a third image including a human head, wherein the first image is generated based on the third image and the object includes a portion of the human head.

Example 11. The method of Example 1, wherein determining the viewpoint can include at least one of determining an association between a light ray and a pixel, determining a focal length, determining a pixel size, determining an image origin, and/or determining a pose.

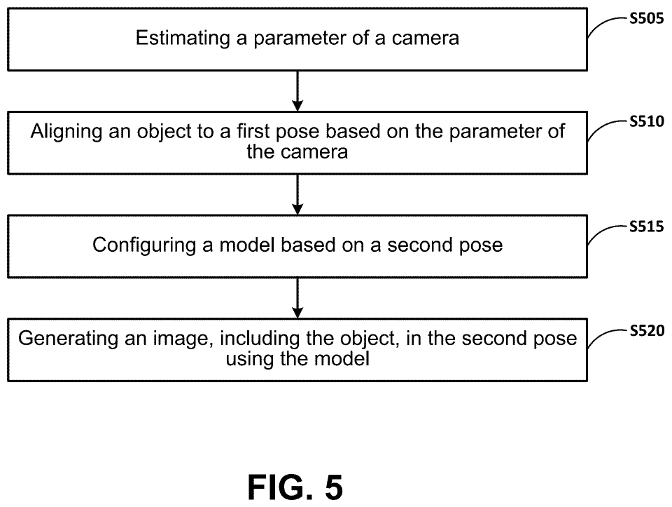

Example 12. FIG. 5 is a block diagram of a method for generating an image according to an example implementation. As shown in FIG. 5, in step S505 estimating a parameter of a camera. In step S510 aligning an object to a first pose based on the parameter of the camera. In step S515 configuring a model based on a second pose. In step S520 generating an image, including the object, in the second pose using the model.

In some implementations, the parameter of the camera can be referred to as a parameter and/or a camera parameter. In some implementations, the parameter of the camera is a two-dimensional (2D) camera parameter. In some implementations the model is configured to convert 2D image data to three-dimensional (3D) image data with the object (e.g., head or face) at a new pose. The (3D) image data can have a high-resolution or ultra-high resolution. In some implementations, the first pose can be referred to as an object pose and/or a predefined pose. In some implementations, the second pose can be referred to as an object pose and/or a target object pose

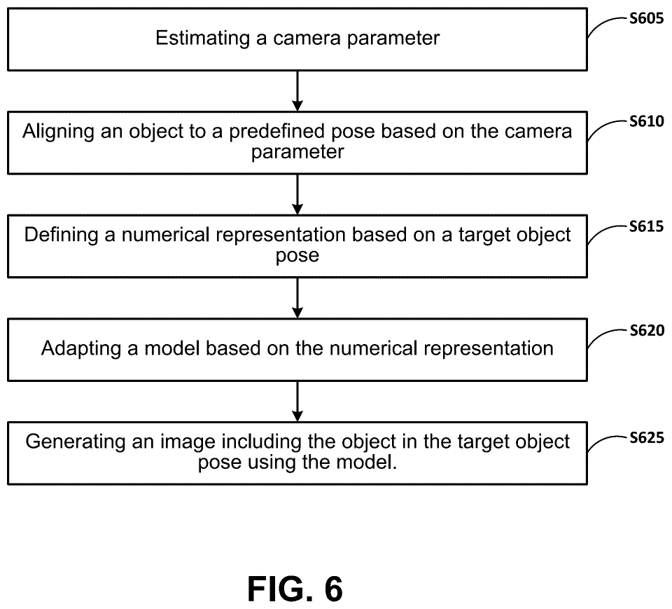

Example 13. FIG. 6 is a block diagram of a method for generating an image according to an example implementation. As shown in FIG. 6, in step S605 estimating a camera parameter. In step S610 aligning an object to a predefined pose based on the camera parameter. In step 615 defining a numerical representation based on a target object pose. In step S620 adapting a model based on the numerical representation. In step 625 generating an image including the object in the target object pose using the model. In some implementations, the camera parameter is a two-dimensional (2D) camera parameter. In some implementations, the numerical representation can be referred to as a representation. In some implementations, the numerical representation is an embedding. In some implementations the model is configured to convert 2D image data to three-dimensional (3D) image data with the object (e.g., head or face) at a new pose. The (3D) image data can have a high-resolution or ultra-high resolution.

Example 14. The method of Example 12 or 13, wherein the model can include a first neural network configured to predict a density and a second neural network configured to predict density and color.

Example 15. The method of Example 14, wherein the density can indicate a three dimensional (3D) spatial smoothness.

Example 16. The method of Example 12 or 13, wherein the adapting of the model can include changing weights associated with a neural network.

Example 17. The method of Example 12 or 13, wherein the model can be trained to generate a 3D image using two-dimensional images.

Example 18. The method of Example 12 or 13, wherein the object is a human face.

Example 19. The method of Example 12 or 13, wherein the model is configured to predict density, predict a color, and integrate the density and the color.

Example 20. The method of Example 19, wherein the model is configured to regularize the integrated density and color.

Example 21. The method of Example 12 or 13, wherein the parameter of the camera includes at least one of an association between a light ray and a pixel, a focal length, a pixel size, an image origin, and a pose of the camera.

Example 22. A method can include any combination of one or more of Example 1 to Example 21.

Example 23. A non-transitory computer-readable storage medium comprising instructions stored thereon that, when executed by at least one processor, are configured to cause a computing system to perform the method of any of Examples 1-22.

Example 24. An apparatus comprising means for performing the method of any of Examples 1-22.

Example 25. An apparatus comprising at least one processor and at least one memory including computer program code, the at least one memory and the computer program code configured to, with the at least one processor, cause the apparatus at least to perform the method of any of Examples 1-22.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described hercin can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening clements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, clements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

1. A method comprising:
determining a viewpoint;
generating a first image using an image generator, the first image including an object in a first orientation based on the viewpoint;
modifying the image generator based on a second orientation; and
generating a second image based on the first image using the modified image generator.

2. The method of claim 1, wherein the image generator is configured to predict a relationship between a pixel channel and a density in a three-dimensional (3D) plane.

3. The method of claim 2, wherein the density indicates a 3D spatial smoothness.

4. The method of claim 1, wherein the modifying of the image generator includes modifying a weight of the image generator that corresponds to the second orientation.

5. The method of claim 1, wherein
generating the second image includes:
predicting a first vector representing density,
predicting a second vector representing color, and
integrating the first vector and the second vector.

6. The method of claim 5, wherein generating the second image further includes regularizing a result of integrating the first vector and the second vector.

7. The method of claim 1, wherein the image generator includes:
a first neural network configured to predict a relationship between a pixel channel and a density in a three-dimensional (3D) plane; and
a second neural network configured to predict a relationship between the pixel channel and the density in the 3D plane and a relationship between the pixel channel and color in the 3D plane.

8. The method of claim 1, wherein
the image generator includes a neural network, and
modifying of the image generator includes changing a weight associated with the neural network that corresponds to a viewing direction.

9. The method of claim 1, wherein the model is trained to generate a 3D image using two-dimensional images.

10. The method of claim 1, further comprising:
receiving a third image including a human head, wherein the first image is generated based on the third image and the object includes a portion of the human head.

11. The method of claim 1, wherein determining a viewpoint includes at least one of:
determining an association between a light ray and a pixel,
determining a focal length,
determining a pixel size,
determining an image origin, or
determining a pose.

12. A non-transitory computer-readable storage medium comprising instructions stored thereon that, when executed by at least one processor, are configured to cause a computing system to:
determine a viewpoint;
generate a first image using an image generator, the first image including an object in a first orientation based on the viewpoint;
modify the image generator based on a second orientation; and
generate a second image based on the first image using the modified image generator.

13. The non-transitory computer-readable storage medium of claim 12, wherein the image generator is configured to predict a relationship between a pixel channel and a density in a three-dimensional (3D) plane.

14. The non-transitory computer-readable storage medium of claim 13, wherein the density indicates a 3D spatial smoothness.

15. The non-transitory computer-readable storage medium of claim 12, wherein the modifying of the image generator includes modifying a weight of the image generator that corresponds to the second orientation.

16. The non-transitory computer-readable storage medium of claim 12, wherein the generating of the second image includes
predicting a first vector representing density,
predicting a second vector representing color, and
integrating the first vector and the second vector.

17. The non-transitory computer-readable storage medium of claim 16, wherein the generating of the second image further includes regularizing a result of integrating the first vector and the second vector.

18. The non-transitory computer-readable storage medium of claim 12, wherein the image generator includes:
a first neural network configured to predict a relationship between a pixel channel and a density in a three-dimensional (3D) plane; and
a second neural network configured to predict a relationship between the pixel channel and the density in the 3D plane and a relationship between the pixel channel and color in the 3D plane.

19. The non-transitory computer-readable storage medium of claim 12, wherein the instructions are further configured to cause the computing system to:
receiving a third image including a human head, wherein the first image is generated based on the third image and the object includes a portion of the human head.

20. An apparatus comprising:
at least one processor; and
at least one memory including computer program code;
the at least one memory and the computer program code configured to, with the at least one processor, cause the apparatus to:
determine a viewpoint;
generate a first image using an image generator, the first image including an object in a first orientation based on the viewpoint;
modify the image generator based on a second orientation; and
generate a second image based on the first image using the modified image generator.
